(19) United States
(12) Patent Application Publication
(10) Pub. No.: US 2013/0271310 A1
(43) Pub. Date: Oct. 17, 2013

(54) ON-BOARD RADAR APPARATUS, DETECTION METHOD, AND DETECTION PROGRAM

(71) Applicant: HONDA ELESYS CO., LTD., Yokohama-shi (JP)

(72) Inventors: Itaru IZUMI, Yokohama-shi (JP); Takeshi KAMBE, Yokohama-shi (JP)

(73) Assignee: Honda elesys Co., Ltd., Yokohama-shi (JP)

(21) Appl. No.: 13/861,014

(22) Filed: Apr. 11, 2013

(30) Foreign Application Priority Data
Apr. 12, 2012 (JP) 2012-091130

(51) Int. Cl. G01S 13/93

(52) U.S. Cl. CPC G01S 13/931
USPC 342/70; 342/368

(57) ABSTRACT

An on-board radar apparatus includes a transmitting unit configured to transmit a transmitted wave, a receiving unit configured to receive a reflected wave obtained by causing an object to reflect the transmitted wave, to generate a reception signal, and to detect the object by performing a signal process on the reception signal, a determination unit configured to determine whether or not the on-board radar apparatus is located in a vehicle interior, and an adjustment unit configured to adjust transmitting characteristics of the transmitting unit or receiving characteristics of the receiving unit so as to compensate for an attenuation in a propagation path of the transmitted wave or the reflected wave when the determination result of the determination unit is affirmative.

### CROSS-REFERENCE TO RELATED APPLICATIONS

Priority is claimed on Japanese Patent Application No. 2012-091130, filed Apr. 12, 2012, the contents of which are entirely incorporated herein by reference.

### BACKGROUND OF THE INVENTION

1. Field of the Invention

The present invention relates to an on-board radar apparatus, a detection method, and a detection program which are used to detect an object.

2. Description of Related Art

Recently, for the purpose of improvement of convenience or safety in vehicles such as automobiles, an on-board radar apparatus using a millimeter wave radar as a detection device has been mounted on vehicles more and more. In such a type of radar apparatus, an FM-CW (Frequency-Modulated Continuous Wave) system capable of simultaneously acquiring a distance and a relative velocity to a target object (object) is generally used as a detection technique in the longitudinal direction. Techniques such as detection of an orientation of an object using a DBF (Digital Beam Forming) method or separation of objects using a MUSIC (MUltiple SIgnal Classification) method are generally used as a detection technique in the transverse direction. Here, the longitudinal direction means the same direction as a forward direction (traveling direction) of a vehicle. In this case, the transverse direction means a direction of orientation (orientation angle) about the forward direction (traveling direction) of a vehicle.

In an on-board radar apparatus using the FM-CW system, beat signals are generated by transmitting modulated waves from a transmitting antenna, receiving reflected waves from a reflecting object (target object) by the use of an antenna array in which receiving antennas are arranged, and mixing the received signals with the transmitted signal by the use of a mixer. Thereafter, frequency components relevant to the reflecting object are extracted by converting the beat signals to digital signals through the use of an A/D (Analog-to-Digital) converter and processing the digital signals by an FFT (Fast Fourier Transformation). The relative velocity and the distance to the target object are calculated by the combination of the frequency components extracted from the ascending section and the descending section in modulation frequency. In the on-board radar apparatus, the orientation of the target object is calculated by detecting an orientation using signal processes such as a DBF or a high-resolution algorithm on the frequency components relevant to the reflecting object.

### SUMMARY OF THE INVENTION

In general, such a type of on-board radar apparatus is mounted on a front part, for example, a front bumper or a front grille, of a vehicle so as to detect information on an object present in the front of the vehicle. JP-A-2011-99683 discloses that a radar apparatus is mounted on a front grille in a sensor fusion system in which the radar apparatus and a camera are used together (refer, in particular, to the description in paragraph [0018] of JP-A-2011-99683).

When a radar apparatus is mounted on a front bumper or a front grille, the radar apparatus may be out of order and may not work, for example, at the time of collision. When the radar apparatus is mounted on the front bumper or the like, electromagnetic waves radiated from the radar apparatus may affect communications between electronic devices in an engine room. When the radar apparatus is mounted in a vehicle interior, the malfunction of the radar apparatus due to collisions or the influence on the communications between the electronic devices arranged in the engine room can be reduced.

However, when the radar apparatus is mounted on a vehicle interior, the field intensity of radio waves transmitted and received by the radar apparatus is attenuated by the front glass. Accordingly, in the related art, there is a problem in that detection performance may be lowered when the radar apparatus is mounted on the vehicle interior.

The present invention is made in consideration of the above-mentioned circumstances and an object thereof is to provide an on-board radar apparatus which can suppress degradation in detection performance when the apparatus is mounted on a vehicle interior, a detection method, and a detection program.

According to an aspect of the present invention, an on-board radar apparatus is provided including: a transmitting unit configured to transmit a transmitted wave; a receiving unit configured to receive a reflected wave obtained by causing an object to reflect the transmitted wave, to generate a reception signal, and to detect the object by performing a signal process on the reception signal; a determination unit configured to determine whether or not the on-board radar apparatus is located in a vehicle interior; and an adjustment unit configured to adjust transmitting characteristics of the transmitting unit or receiving characteristics of the receiving unit so as to compensate for an attenuation in a propagation path of the transmitted wave or the reflected wave when the determination result of the determination unit is affirmative.

In the on-board radar apparatus, the adjustment unit may adjust the transmitting characteristics by increasing a transmitting output power of the transmitting unit depending on the attenuation.

In the on-board radar apparatus, the adjustment unit may adjust the receiving characteristics by increasing a receiving gain of the receiving unit depending on the attenuation.

In the on-board radar apparatus, the adjustment unit may adjust the receiving characteristics by multiplying a coefficient corresponding to an increase in receiving gain of the receiving unit based on the attenuation by a signal component obtained in the course of causing the receiving unit to perform the signal process on the reception signal.

The on-board radar apparatus may be housed in the same casing as a camera apparatus.

According to another aspect of the present invention, a detection method is provided using an on-board radar apparatus having a transmitting unit configured to transmit a transmitted wave and a receiving unit configured to receive a reflected wave obtained by causing an object to reflect the transmitted wave, to generate a reception signal, and to detect the object by performing a signal process on the reception signal, the detection method including the steps of: determining whether or not the on-board radar apparatus is located in a vehicle interior; and adjusting transmitting characteristics of the transmitting unit or receiving characteristics of the receiving unit so as to compensate for an attenuation in a propagation path of the transmitted wave or the reflected wave when the determination result of the determination unit is affirmative.

According to another aspect of the present invention, a detection program is provided causing a computer of an on-board radar apparatus, which includes a transmitting unit configured to transmit a transmitted wave and a receiving unit configured to receive a reflected wave obtained by causing an object to reflect the transmitted wave, to generate a reception signal, and to detect the object by performing a signal process on the reception signal, to perform the sequences of: determining whether or not the on-board radar apparatus is located in a vehicle interior; and adjusting transmitting characteristics of the transmitting unit or receiving characteristics of the receiving unit so as to compensate for an attenuation in a propagation path of the transmitted wave or the reflected wave when the determination result is affirmative.

According to the aspects of the present invention, it is possible to provide an on-board radar apparatus that can suppress degradation in detection performance and can be mounted on a vehicle interior.

### BRIEF DESCRIPTION OF THE DRAWINGS

FIG. 1 is a block diagram illustrating a configuration of an on-board radar apparatus according to an embodiment of the present invention.

FIGS. 2A and 2B are diagrams illustrating examples where the on-board radar apparatus according to the embodiment of the present invention is mounted.

FIG. 3 is a flowchart illustrating an example of a sequence of processes performed by the on-board radar apparatus according to the embodiment of the present invention.

### DETAILED DESCRIPTION OF THE INVENTION

Hereinafter, first to fourth embodiments of the present invention will be sequentially described referring to the accompanying drawings.

### First Embodiment

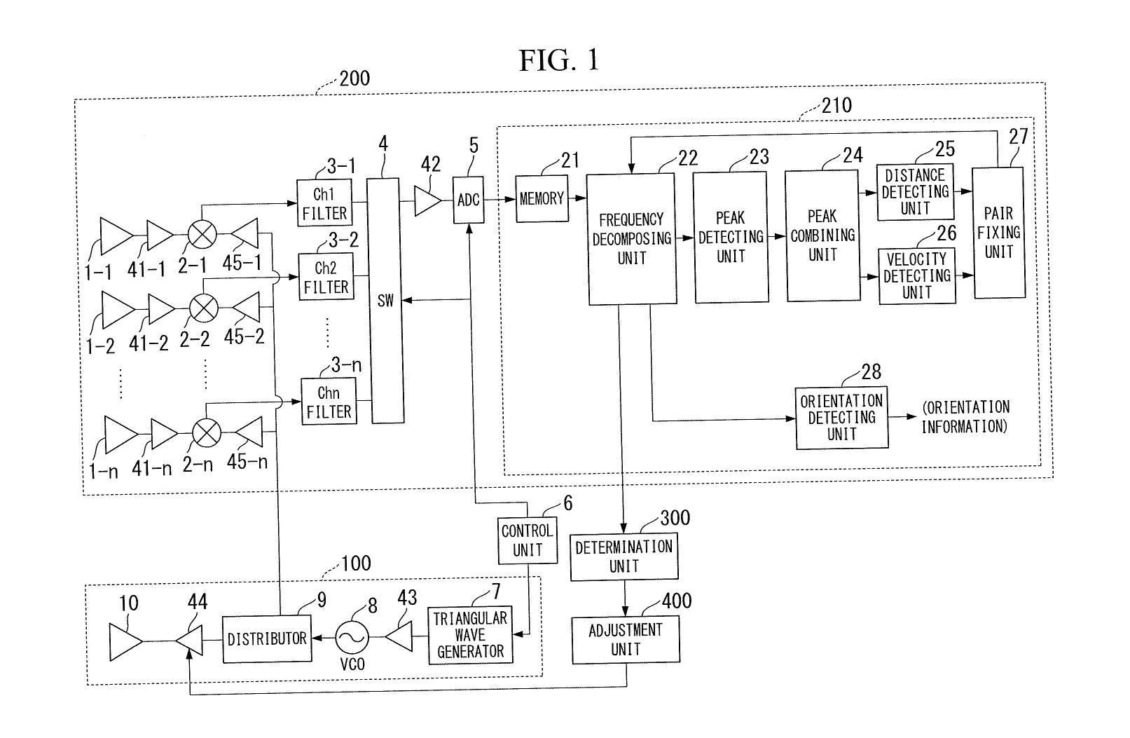

FIG. 1 is a block diagram illustrating a configuration of an on-board radar apparatus according to a first embodiment of the present invention. In this embodiment, an electronic scanning radar apparatus (FM-CW millimeter wave radar apparatus) will be described as an example of the on-board radar apparatus. The on-board radar apparatus can be mounted on a vehicle interior (for example, a room mirror) or a vehicle exterior (for example, a front grille or a front bumper) so as to transmit radio waves (transmitted waves) forward from the vehicle (for example, an automobile) and to detect information on an object (a target) present in the front of the vehicle.

An electronic scanning radar apparatus (FM-CW millimeter wave radar apparatus) will be described as an example in this embodiment, but the present invention is not limited to the example. The present invention can be applied to any apparatus as long as it is a radar apparatus capable of controlling transmitting characteristics such as transmitting output power or receiving characteristics such as a receiving gain.

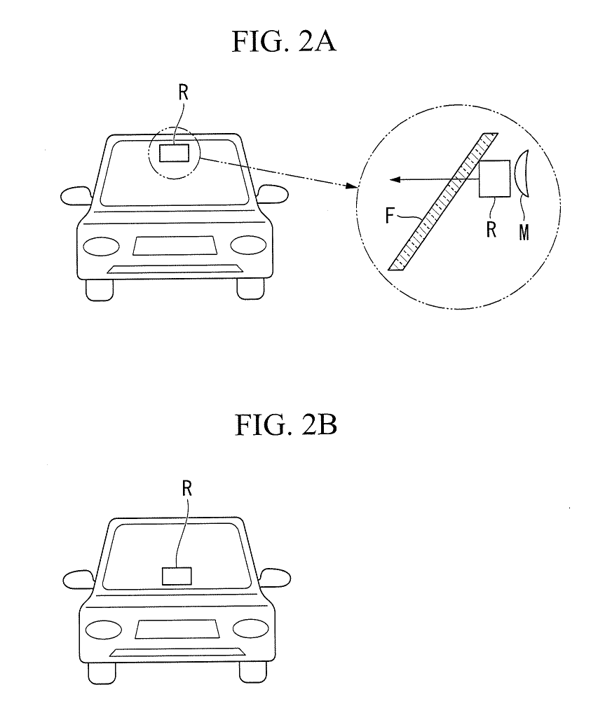

FIGS. 2A and 2B are diagrams illustrating examples where the on-board radar apparatus is mounted on a vehicle interior. In the example shown in FIG. 2A, as shown in a dotted circle, the radar apparatus R according to this embodiment is mounted between a room mirror M and a front glass F in a state where the transmitting and receiving direction of radio waves is set to be parallel to the traveling direction (direction indicated by an arrow in the dotted circle). In the example shown in FIG. 2B, the radar apparatus R is mounted on a dash board in a state where the transmitting and receiving direction of radio waves is set to be parallel to the traveling direction of the vehicle.

However, without being limited to the examples shown in FIGS. 2A and 2B, the radar apparatus may be mounted on any of four corners of the front glass or may be formed as a unified body with the room mirror. That is, the radar apparatus may be mounted on any location of the vehicle interior, as long as it can radiate a transmitted wave to an object and receive the reflected wave thereof. Although not shown in the drawings, the radar apparatus may be mounted on any location of the vehicle exterior such as a front bumper or a front grille of the vehicle, as long as it can radiate a transmitted wave to an object and receive the reflected wave thereof.

Description will be made referring to FIG. 1 again. As shown in the drawing, the radar apparatus includes a transmitting unit 100, a receiving unit 200, a determination unit 300, an adjustment unit 400, and a control unit 6. The transmitting unit 100 serves to transmit a transmitted wave frequency-modulated with a predetermined triangular wave under the control of the control unit 6. The receiving unit 200 serves to receive a reflected wave arriving by causing an object to reflect the transmitted wave, to generate a reception signal, and to detect the object by performing a signal process on the reception signal, under the control of the control unit 6.

The determination unit 300 determines whether or not the radar apparatus is located in the vehicle interior. In this embodiment, the determination unit 300 determines whether or not the radar apparatus is located in the vehicle interior, based on the detection level of an FMCW modulated wave or a CW modulated wave acquired by the frequency decomposing unit 22. In this embodiment, the following conditions are used as determination conditions for causing the determination unit 300 to determine whether or not the radar apparatus is located in the vehicle interior.

(1) Determination Condition when the Radar Apparatus is in an Aiming State

First condition: The detection level is greater than or equal to an upper limit of a reference detection level obtained when a transmitted wave is radiated to a reference target (reflector) used for aiming.

Second condition: The detection level is less than a lower limit of the reference detection level.

The determination unit 300 determines that the radar apparatus is located in the vehicle exterior when the first condition is satisfied, and determines that the radar apparatus is located in the vehicle interior when the second condition is satisfied. In other words, the determination unit 300 determines that the radar apparatus is not located in the vehicle interior when the first condition is satisfied, and determines that the radar apparatus is not located in the vehicle exterior when the second condition is satisfied.

(2) Determination Condition when the Radar Apparatus is Not in an Aiming State but the Vehicle having the Radar Apparatus Mounted Thereon is in a Traveling State.

When the vehicle having the radar apparatus mounted thereon is traveling, the determination unit 300 determines whether or not the radar apparatus is located in the vehicle interior, based on the detection level of a FMCW modulated wave or a CW modulated wave acquired by the frequency decomposing unit 22. Here, the determination unit 300 monitors ambient reflected waves and a close-in detection level in a traveling section of a predetermined time or a predetermined distance during traveling, can determine that radio waves are attenuated by the front glass when the close-in detection level is lower than a specified value and the ambient reflection level is low, and can determine that the radar apparatus is located in the vehicle interior based on the attenuation of radio waves.

In this case, conditions for determining that the radar apparatus is located in the vehicle interior during the vehicle's traveling can be expressed as follows.

The frequency at which the maximum detection level is greater than or equal to a specified value is small.

Within the detectable range, the number of peaks in the detection level is large but the difference between the peak of the maximum level and the close-in average floor level is small. Here, the close-in average floor level means a value obtained by calculating and averaging the total sum of information pieces (information pieces of portions other than peaks) which are lower than a predetermined value (specified value) at a close-in distance out of information input to the determination unit 300 from the frequency decomposing unit 22, that is, the average value of the portions other than the peaks.

The average value of the detection levels of a close-in spectrum is lower than a specified value.

Within the detectable range, the average level (the average of spectrum including the peaks) of the spectrum is small.

These conditions are conditions for determining that the radar apparatus is located in the vehicle exterior and can be rewritten as third to fifth conditions.

Third condition: The number of peaks detected in the detection level is greater than or equal to than a specified value.

Fourth condition: The maximum level of the detection level is greater than or equal to a specified value.

Fifth condition: The difference between the maximum level of the detection level and the close-in average floor level is greater than or equal to a specified value.

In this embodiment, the determination unit 300 determines that the radar apparatus is located in the vehicle exterior when all the third to fifth conditions are satisfied, and determines that the radar apparatus is located in the vehicle interior when any one of the third to fifth conditions is not satisfied. This embodiment is not limited to this example, but for example, it may be determined that the radar apparatus is located in the vehicle exterior when any one or a predetermined combination of the third to fifth conditions is satisfied and it may be determined that the radar apparatus is located in the vehicle interior otherwise.

In this embodiment, the conditions (the third to fifth conditions) for determining whether or not the radar apparatus is located in the vehicle exterior are used as the determination conditions when the vehicle is traveling, but these determination conditions can be replaced with the above-mentioned conditions for determining whether or not the radar apparatus is located in the vehicle interior.

Description will be made referring to FIG. 1 again. The adjustment unit 400 adjusts transmitting characteristics of the transmitting unit 100 so as to compensate for the attenuation in the propagation path of the transmitted wave or the reflected wave when the determination unit 300 determines that the radar apparatus is located in the vehicle interior. In this embodiment, the adjustment unit 400 adjusts transmitting output power as the transmitting characteristics of the transmitting unit 100. The adjustment unit 400 may adjust receiving characteristics of the receiving unit 200. The cases where the receiving characteristics are adjusted will be described later as a second embodiment and a third embodiment of the present invention.

The transmitting unit 100 includes a triangular wave generator 7, an amplifier 43, a voltage-controlled oscillator (VCO) 8, a distributor 9, an amplifier 44, and a transmitting antenna 10. The receiving unit 200 includes n (where n is two or more) receiving antennas 1-1 to 1-n, n amplifiers 41-1 to 41-n, n mixers 2-1 to 2-n, n filters 3-1 to 3-n, a switch (SW) 4, an amplifier 42, an A/D converter (ADC) 5, n amplifiers 45-1 to 45-n, and a signal processing unit 210. The signal processing unit 210 includes a memory 21, a frequency decomposing unit 22, a peak detecting unit 23, a peak combining unit 24, a distance detecting unit 25, a velocity detecting unit 26, a pair fixing unit 27, and an orientation detecting unit 28.

In this embodiment, the radar apparatus includes a receiving system of n channels (Ch) constituting a receiving antenna array. That is, the radar apparatus includes the receiving antennas 1-1 to 1-n, the amplifiers 41-1 to 41-n, the mixers 2-1 to 2-n, the filters 3-1 to 3-n, and the amplifiers 45-1 to 45-n, for the channels.

An operation of detecting a target object will be described below as an example of a basic operation of the radar apparatus according to this embodiment. This basic operation will be described in the same way as that the operation of the apparatus according to the related art is described.

The transmitting unit 100 transmits a transmitted wave frequency-modulated using a predetermined triangular wave signal. That is, the triangular wave generator 7 generates a triangular wave signal and outputs the generated triangular wave signal to the amplifier 43 under the control of the control unit 6. The amplifier 43 amplifies the triangular wave signal input from the triangular wave generator 7 and outputs the amplified triangular wave signal to the VCO 8. The VCO 8 outputs a signal, which is obtained by frequency-modulating the triangular wave signal, as a transmission signal to the distributor 9 based on the triangular wave signal input from the amplifier 43.

The distributor 9 distributes the transmission signal input from the VCO 8 into two signals, outputs one distributed signal to the amplifier 44, and outputs the other distributed signal to the amplifiers 45-1 to 45-n. The amplifier 44 amplifies the signal input from the distributor 9 and outputs the amplified signal to the transmitting antenna 10. The transmitting antenna 10 transmits the signal input from the amplifier 44 as a transmitted wave in a wireless manner. The transmitted wave is reflected by a target object.

On the other hand, the receiving unit 200 receives a reflected wave arriving by causing the target object to reflect the transmitted wave transmitted from the transmitting unit 100, generates a reception signal, and detects the target object by performing a signal process on the reception signal. In this embodiment, the receiving unit 200 detects a distance to the target object from the radar apparatus, a relative velocity of the target object to the radar apparatus, and an orientation (orientation in which the target object is located) in which the reflected wave arrives.

The detection operation of the receiving unit 200 will be described below in more detail. The receiving antennas 1-1 to 1-n included in the receiving unit 200 receive a reflected wave (that is, a received wave) arriving by causing the target object to reflect the transmitted wave transmitted from the transmitting antenna 10 and output the received wave to the amplifiers 41-1 to 41-n, respectively. The amplifiers 41-1 to 41-n amplify the received waves input from the receiving antennas 1-1 to 1-n and output the amplified received waves to the mixers 2-1 to 2-n, respectively.

The amplifiers 45-1 to 45-n amplify the signal (the distributed signal of the transmission signal) input from the distributor 9 and output the amplified signals to the mixers 2-1 to 2-n, respectively. The mixers 2-1 to 2-n mix the signals of the received waves input from the amplifiers 41-1 to 41-n with the signals (the signal of the transmitted wave transmitted from the transmitting antenna 10) input from the amplifiers 45-1 to 45-n, respectively, to generate beat signals corresponding to frequency differences therebetween, and output the generated beat signals to the filters 3-1 to 3-n, respectively.

The filters 3-1 to 3-n band-limit the beat signals (the beat signals of channels 1 to n corresponding to the receiving antennas 1-1 to 1-n) input from the mixers 2-1 to 2-n, respectively, and output the band-limited beat signals to the switch 4. The switch 4 sequentially switches and outputs the beat signals input from the filters 3-1 to 3-n to the amplifier 42 in response to a sampling signal input from the control unit 6. The amplifier 42 amplifies the beat signals input from the switch 4 and outputs the amplified beat signals to the A/D converter 5.

The A/D converter 5 A/D converts the beat signals (the beat signals of channels 1 to n corresponding to the receiving antennas 1-1 to 1-n), which are input from the switch 4 in synchronization with the sampling signal, in response to the sampling signal input from the control unit 6 to convert analog signals into digital signals in synchronization with the sampling signal, and sequentially store the resultant digital signals in a waveform storage area of the memory 21 of the signal processing unit 210.

The memory 21 stores the digital signals (beat signals) acquired by the A/D converter 5 in the waveform storage area thereof in correlation with the antennas 1-1 to 1-n. The digital signals are time-series data of ascending portions and descending portions. For example, when 256 values are sampled in each of the ascending portion and the descending portion for each of the receiving antennas 1-1 to 1-n, 2×256×number of antennas data pieces are stored in the waveform storage area of the memory 21 of the frequency decomposing unit 22.

The frequency decomposing unit 22 frequency-transforms sampled data of the beat signals stored in the memory 21 in each of the ascending portion and the descending portion of a triangular wave at discrete times through the use of frequency decomposition (for example, Fourier transformation). That is, the frequency decomposing unit 22 frequency-decomposes the beat signals to beat frequencies having a predetermined frequency bandwidth, and calculates complex data based on the beat signals decomposed for each beat frequency. As a result, a signal level for each beat frequency to which the beat signals are frequency-decomposed is obtained in each of the ascending portion and the descending portion of a triangular wave. The result is output to the peak detecting unit 23 and the orientation detecting unit 28.

Here, the complex data have a phase difference depending on an angle θ corresponding to the incident angle of the reflected wave on the receiving antennas 1-1 to 1-n, and the absolute values (for example, received intensity or amplitude) of the complex data in a complex plane are equal to each other. The orientation detecting unit 28 to be described later can detect the orientation (angle θ) of the target object using the phase difference through the use of a signal process such as a DBF or a high-resolution algorithm.

The peak detecting unit 23 detects (senses) presence of a target object for each beat frequency by detecting the beat frequencies having a peak value (for example, the peak value of the received intensity or the amplitude) of complex data greater than a predetermined numerical value in each of the ascending portion and the descending portion of a triangular wave based on the information input from the frequency decomposing unit 22, and selects the detected beat frequency corresponding to the target object as a target frequency. The peak detecting unit 23 outputs the detection result (the beat frequency as the target frequency and the peak value thereof) of the target frequency to the peak combining unit 24.

The peak combining unit 24 combines the beat frequency in each of the ascending portion and the descending portion and the peak value thereof, which are included in the information (the beat frequency as the target frequency and the peak value thereof) input from the peak detecting unit 23, in a matrix shape in a round-robin manner, combines all the beat frequencies in the ascending portions and the descending portions, and sequentially outputs the combination result to the distance detecting unit 25 and the velocity detecting unit 26.

The distance detecting unit 25 calculates a distance r to a target object based on the sum of the beat frequencies (the target frequencies) in the combinations of the ascending portion and the descending portion sequentially input from the peak combining unit 24, and outputs the calculation result (which includes the peak values) to the pair fixing unit 27.

The velocity detecting unit 26 calculates a relative velocity v to the target object based on the difference value of the beat frequencies (target frequencies) between the combinations of the ascending portion and the descending portion sequentially input from the peak combining unit 24, and outputs the calculation result (which includes the peak values) to the pair fixing unit 27.

The pair fixing unit 27 determines an appropriate combination of the peaks in the ascending portion and the descending portion corresponding to each target object based on the information input from the distance detecting unit 25 and the information input from the velocity detecting unit 26, fixes a pair of peaks in the ascending portion and the descending portion, and outputs a target group number representing the fixed pair (the distance r, the relative velocity v, and the frequency point) to the frequency decomposing unit 22.

The orientation detecting unit 28 detects and outputs the orientation (orientation angle) of the target object based on the information input from the frequency decomposing unit 22. Here, various methods including known methods may be used as a method (for example, algorithm) used for the orientation detecting unit 28 to detect the orientation of a target object. Specifically, the orientation detecting unit 28 can detect the orientation of a target object using an AR spectrum estimating method as a high-resolution algorithm, a MUSIC (Multiple Signal Classification) method, a modified covariance (MCOV) method, a DBF (Digital Beam Forming) method, or the like.

The known technique disclosed in JP-A-2011-163883 or the like can be used as the principle of detecting the distance to a target object, the relative velocity to a target object, and the orientation of a target object.

The control unit 6 controls the overall units of the radar apparatus based on a control program stored in a ROM (Read Only Memory) not shown. For example, the control unit 6 controls a process of causing the triangular wave generator 7 to generate a triangular wave signal, generates a predetermined sampling signal, and outputs the generated sampling signal to the switch 4 and the A/D converter 5. The control unit 6 is constructed, for example, using a microcomputer or the like.

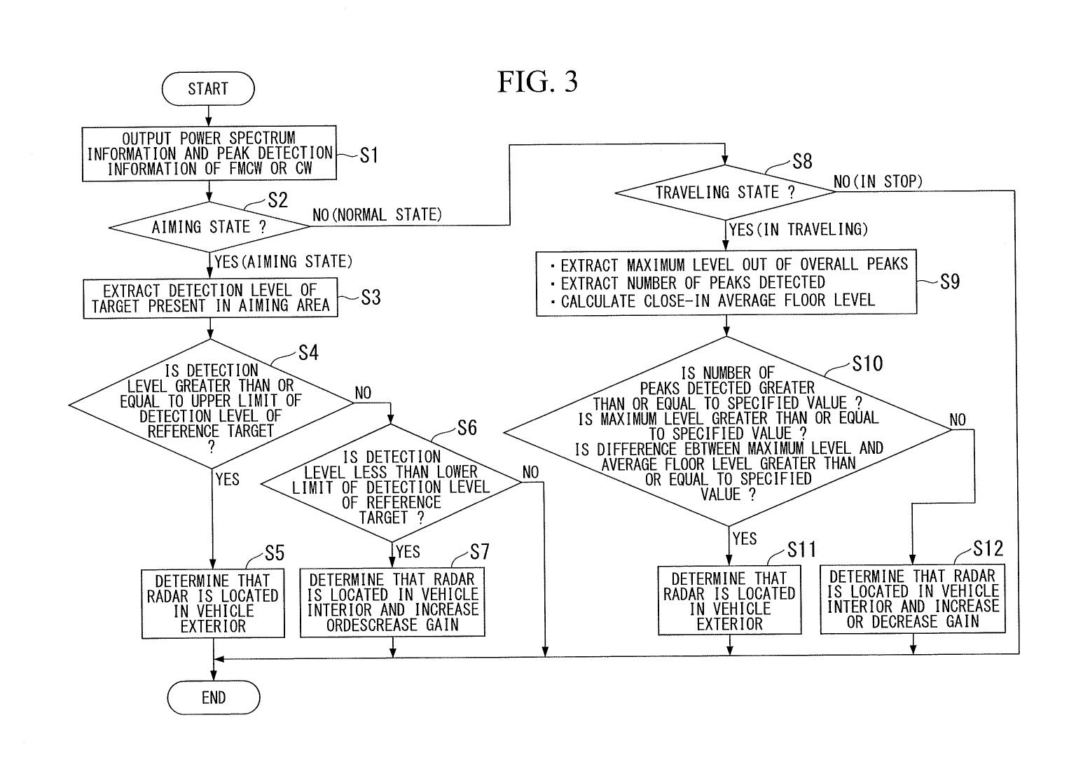

An operation of preventing degradation in detection performance on a location on which the radar apparatus is mounted will be described below as a characteristic operation of the radar apparatus according to this embodiment with reference to the flowchart shown in FIG. 3.

FIG. 3 is a flowchart illustrating an example of a sequence of processes of preventing degradation in detection performance as an example of the operation of the radar apparatus.

Schematically, according to the radar apparatus, the determination unit 300 determines whether or not the radar apparatus is located in the vehicle interior (or whether or not the radar apparatus is located in the vehicle exterior). When the determination result is affirmative (or when the determination result on whether or not the radar apparatus is located in the vehicle exterior is negative), the adjustment unit 400 adjusts the transmitting output power, which is a kind of transmitting characteristic of the transmitting unit 100, so as to compensate for the attenuation in the propagation path of the transmitted wave transmitted from the transmitting unit 100 or the reflected wave received by the receiving unit 200. In this embodiment, the adjustment unit 400 increases the transmitting output power of the transmitting unit 100 depending on the attenuation in the propagation path of the transmitted wave transmitted from the transmitting unit 100 or the reflected wave received by the receiving unit 200.

In this embodiment, it is assumed that the initial value of the transmitting output power of the transmitting unit 100 is set on the assumption that the radar apparatus is mounted on the vehicle exterior (for example, the front grille).

This embodiment is not limited to this example, but the initial value of the transmitting output power of the transmitting unit 100 on the assumption that the radar apparatus is mounted on the vehicle interior.

The characteristic operation of the radar apparatus will be described below when the radar apparatus is in an aiming state in the step of manufacturing a vehicle having the radar apparatus mounted thereon.

In the aiming, a reference target (CR) having a prescribed radar reflection cross-sectional area (RCS) is disposed at a predetermined position in an aiming area in front of the vehicle and the direction of the radar apparatus is set so as to cause the intensity of a reflected wave to have a peak when a transmitted wave is applied to the reference target.

At the time of aiming, the determination unit 300 receives power spectrum information or peak detection information acquired by the frequency decomposing unit 22 when a reflected wave is received from the reference target (step S1). When the radar apparatus is in the aiming state (YES in step S2), the determination unit 300 extracts a detection level of the reference target present in the aiming area from the information acquired from the frequency decomposing unit 22 (step S3). Then, the determination unit 300 determines whether or not the detection level is greater than or equal to the upper limit of the detection level of the reference target, that is, whether or not the above-mentioned first condition is satisfied (step S4). Here, the upper limit of the detection level means a prescribed value corresponding to the detection level of the reflected wave from the reference target in a state where the front glass is not present (that is, a state where the radar apparatus is located in the vehicle exterior). When it is determined that the detection level is greater than or equal to the upper limit of the detection level of the reference target (YES in step S4), the determination unit 300 determines that the radar apparatus is located in the vehicle exterior (step S5) and ends the sequence of processes. In this case, the transmitting output power of the transmitting unit 100 is not adjusted by the adjustment unit 400, and the initial value (the transmitting output power set on the assumption that the radar apparatus is located in the vehicle exterior) is maintained as the transmitting output power of the transmitting unit 100.

On the other hand, when it is determined that the detection level is not greater than or equal to the upper limit of the detection level of the reference target (NO in step S4), the determination unit 300 determines whether or not the detection level is less than the lower limit of the detection level of the reference target, that is, whether or not the above-mentioned second condition is satisfied (step S6). Here, the lower limit of the detection level means a prescribed value corresponding to the detection level of the reflected wave from the reference target in a state where the front glass is present (that is, in a state where the radar apparatus is located in the vehicle interior). When it is determined that the detection level is not less than the lower limit of the detection level of the reference target (NO in step S6), the sequence of processes is ended. In this case, it may be reported that any of the first condition and the second condition is not satisfied.

On the contrary, when it is determined that the detection level is less than the lower limit of the detection level of the reference target (YES in step S6), the determination unit 300 determines that the radar apparatus is located in the vehicle interior and the adjustment unit 400 increases the transmitting output power of the transmitting unit 100 (step S7). In this manner, when the detection level is less than the lower limit of the detection level of the reference target, it can be thought that the radar apparatus is under environments in which the intensity of the transmitted wave or the reflected wave due to the front glass, and it can be accordingly determined that the radar apparatus is located in the vehicle interior.

In this embodiment, when it is determined that the detection level is less than the lower limit of the detection level of the reference target (YES in step S6), the adjustment unit 400 increases the transmitting output power of the transmitting unit 100 by increasing the amplification degree (gain) of the amplifier 44 of the transmitting unit 100 so as to compensate for the attenuation of the transmitted wave or the reflected wave due to the front glass of the vehicle (step S7). The increase in amplification degree of the amplifier 44 is acquired in advance through experiments or the like and is stored, for example, in a storage unit (not shown) of the adjustment unit 400. For example, the detection level of the reflected wave form the reference target in the state where the front glass is not present and the detection level of the reflected wave from the reference target in the state where the front glass is present are measured, and the increase in amplification degree of the amplifier 44 of the transmitting unit 100 is set so as to compensate for the difference between the detection levels of the reflected waves. That is, the increase in amplification degree of the amplifier 44 is set depending on the attenuation of the transmitted wave or the reflected wave due to the front glass, and the adjustment unit 400 increases the amplification degree of the amplifier 44 by the amount corresponding to the difference between the detection levels of the reflected waves.

In this manner, according to this embodiment, when the radar apparatus in the aiming state, it is determined whether or not the radar apparatus is located in the vehicle interior, based on the detection level when the reflected wave is received from the reference target, and the transmitting output power of the transmitting unit 100 is increased when it is determined that the radar apparatus is located in the vehicle interior. Accordingly, the attenuation of the transmitted wave or the reflected wave due to the front glass of the vehicle is compensated for and the degradation in detection performance is suppressed. Therefore, according to this embodiment, even when the radar apparatus is mounted on the vehicle interior, it is possible to obtain the same detection performance as obtained when the radar apparatus is mounted on the vehicle exterior, for example, the front bumper.

The operation when the radar apparatus is not in the aiming state will be described below.

When it is determined that the radar apparatus is not in the aiming state (NO in step S2), the determination unit 300 determines whether or not the vehicle is traveling (step S8). For example, the determination unit 300 acquires information on a vehicle velocity from an engine controller of the vehicle and determines whether or not the vehicle is traveling based on the acquired information. Here, when it is determined that the vehicle is not traveling but is stopped (NO in step S8), the sequence of processes is ended. In this case, the transmitting output power of the transmitting unit 100 is not adjusted by the adjustment unit 400 and the initial value thereof is maintained as the transmitting output power of the transmitting unit 100.

On the other hand, when it is determined that the vehicle is traveling (YES in step S8), the determination unit 300 extracts the peak of the maximum level out of the overall peaks of the detection level and the number of peaks detected from the information input from the frequency decomposing unit 22, and calculates the close-in average floor level (step S9). Then, the determination unit 300 determines whether the extracted number of peaks is greater than or equal to a prescribed value (that is, whether or not the above-mentioned third condition is satisfied), whether the extracted maximum level is greater than or equal to a prescribed value (that is, whether or not the above-mentioned fourth conditions is satisfied), and whether the difference between the extracted maximum level and the calculated close-in average floor level is greater than or equal to a prescribed value (that is, whether or not the above-mentioned fifth condition is satisfied) (step S10).

Here, when the third to fifth conditions are satisfied (YES in step S10), the determination unit 300 determines that the radar apparatus is located in the vehicle exterior (step S11) and ends the sequence of processes. In this case, the transmitting output power of the transmitting unit 100 is not adjusted by the adjustment unit 400 and the initial value is maintained as the transmitting output power of the transmitting unit 100.

On the other hand, when the third to fifth conditions are not satisfied (NO in step S10), the determination unit 300 determines that the radar apparatus is located in the vehicle interior, and the adjustment unit 400 increases the amplification degree (gain) of the amplifier 44 of the transmitting unit 100 to increase the transmitting output power of the transmitting unit 100 (step S12), similarly to step S7.

As described above, conditions for determining whether or not the radar apparatus is located in the vehicle interior may be used instead of the third to fifth conditions for determining whether or not the radar apparatus is located in the vehicle exterior in step S10.

In this manner, when the radar apparatus is not in the aiming state but the vehicle is traveling, the determination unit 300 monitors the detection levels of the ambient reflected waves during the vehicle traveling and determines whether or not the radar apparatus is located in the vehicle exterior (or whether or not the radar apparatus is located in the vehicle interior) based on the detection levels of the reflected waves, and the transmitting output power of the transmitting unit 100 is increased when it is determined that the radar apparatus is located in the vehicle interior. Accordingly, even when the transmitting output power of the transmitting unit 100 is not adjusted at the time of aiming, the transmitting output power of the transmitting unit 100 is adjusted during the vehicle traveling and the attenuation of the transmitted wave or the reflected wave due to the front glass of the vehicle is compensated for. Therefore, even when the radar apparatus is mounted on the vehicle interior, it is possible to obtain the same detection performance as obtained when the radar apparatus is mounted on the vehicle exterior.

Therefore, according to this embodiment, it is possible to mount the radar apparatus on the vehicle interior while maintaining the detection performance.

According to this embodiment, since a millimeter wave band using antenna elements of an on-board small-sized antenna array is used, conditions such as refraction of radio waves due to the front glass of the vehicle are identical for the antenna elements of the antenna array. Accordingly, the relative phase difference between the antenna elements of the antenna array is hardly affected by the front glass at the time of detecting an orientation or detecting a distance. Therefore, similarly to the case where the radar apparatus is mounted on the vehicle exterior, it is possible to correctly detect an orientation or a distance based on the relative phase difference even when the radar apparatus is mounted on the vehicle interior.

In general, when the radar apparatus is mounted on the front grille or the front bumper of the vehicle exterior, the radar apparatus may not be used due to attachment of clay or snow during traveling. However, according to this embodiment, since the radar apparatus can be mounted on the vehicle interior, it is possible to remove the attachments of clay or the like with a front wiper or the like. Therefore, it is possible to allow the radar apparatus to operate without being affected by the attachments of clay or the like, thereby enlarging the actual utilization range of the radar apparatus.

### Second Embodiment

A second embodiment of the present invention will be described below.

In this embodiment, unlike the first embodiment, the adjustment unit 400 adjusts receiving characteristics of the receiving unit 200 so as to compensate for the attenuation in the propagation path of the transmitted wave or the reflected wave when the determination unit 300 determines that the radar apparatus is located in the vehicle interior. In this embodiment, the adjustment unit 400 adjusts a receiving gain as the receiving characteristics of the receiving unit 200. Specifically, the adjustment unit 400 adjusts amplification degrees of the amplifiers 41-1 to 41-n constituting the receiving unit 200.

That is, in this embodiment, the adjustment unit 400 increases the amplification degrees of the amplifiers 41-1 to 41-n of the receiving unit 200 so as to compensate for the attenuation of the transmitted wave or the reflected wave due to the front glass of the vehicle. The increases in the amplification degree of the amplifiers 41-1 to 41-n are acquired in advance through experiments or the like and are stored, for example, in a storage unit (not shown) of the adjustment unit 400. For example, the detection level of the reflected wave from the reference target in the state where the front glass is not present and the detection level of the reflected wave from the reference target in the state where the front glass is present are measured and the increases in the amplification degrees of the amplifiers 41-1 to 41-n of the receiving unit 200 are set so as to compensate for the difference between the detection levels of the reflected waves. That is, the increases in the amplification degrees of the amplifiers 41-1 to 41-n are set to a value based on the attenuation of the transmitted wave or the reflected wave due to the front glass, and the adjustment unit 400 increases the amplification degrees of the amplifiers 41-1 to 41-n by an amount corresponding to the difference between the detection levels of the reflected waves. The other is the same as described in the first embodiment.

According to this embodiment, since the receiving gain of the receiving unit 200 is adjusted, it is possible to compensate for the attenuation in the propagation path of the transmitted wave or the reflected wave without increasing the transmitting output power of the transmitting unit 100. Therefore, compared with the first embodiment, it is possible to further suppress the influence of the transmitted wave transmitted from the transmitting unit 100 on communications of peripheral electronic devices.

### Third Embodiment

A third embodiment of the present invention will be described below.

In this embodiment, unlike the first embodiment, the adjustment unit 400 adjusts receiving characteristics of the receiving unit 200 by multiplying a coefficient, which corresponds to an increase in the receiving gain of the receiving unit 200 based on the attenuation in the propagation path of the transmitted wave or the reflected wave, by signal components obtained through the signal process in the frequency decomposing unit 22 of the receiving unit 200, when the determination unit 300 determines that the radar apparatus is located in the vehicle interior. For example, the adjustment unit 400 multiplies the coefficient by the beat signals frequency-transformed at discrete times through the frequency decomposition (for example, Fourier transformation) in the frequency decomposing unit 22.

That is, in this embodiment, the adjustment unit 400 multiplies the coefficient by the beat signals frequency-transformed in the frequency decomposing unit 22 so as to compensate for the attenuation of the transmitted wave or the reflected wave due to the front glass of the vehicle. The coefficient is acquired in advance through experiments or the like and is stored, for example, in a storage unit (not shown) of the adjustment unit 400. For example, the detection level of the reflected wave from the reference target in the state where the front glass is not present and the detection level of the reflected wave from the reference target in the state where the front glass is present are measured and the coefficient is set to compensate for the difference between the detection levels of the reflected waves. The other is the same as described in the first embodiment.

According to this embodiment, it is possible to obtain the same advantages as obtained when the receiving gain is increased in the second embodiment, through the use of software processes in the frequency decomposing unit 22. Therefore, it is possible to obtain the same advantages as obtained in the second embodiment without changing the hardware configuration.

### Fourth Embodiment

A fourth embodiment o the present invention will be described below.

In this embodiment, the radar apparatus according to any one of the first to third embodiments is formed as a unified body with a camera apparatus. That is, the radar apparatus is housed in the same casing as the camera apparatus. Here, the camera apparatus is used to acquire, for example, an image used to recognize an image of a target object around the vehicle and, for example, the imaging direction thereof is directed to the traveling direction of the vehicle.

According to this embodiment, since the radar apparatus and the camera apparatus are housed in a single casing, it is possible to facilitate communications between plural sensors including the radar apparatus and the camera apparatus. Therefore, for example, cables for connecting the plural sensors to each other are not necessary and it is thus possible to simplify the apparatus configuration and to reduce the apparatus cost.

In the first to fourth embodiments, the present invention is described as a radar apparatus. However, the present invention may be described as a detection method of detecting a target object. In this case, the detection method according to the present invention is a detection method using an on-board radar apparatus having a transmitting unit configured to transmit a transmitted wave and a receiving unit configured to receive a reflected wave obtained by causing an object to reflect the transmitted wave, to generate a reception signal, and to detect the object by performing a signal process on the reception signal, the detection method including the steps of: determining whether or not the on-board radar apparatus is located in a vehicle interior; and adjusting transmitting characteristics of the transmitting unit or receiving characteristics of the receiving unit so as to compensate for an attenuation in a propagation path of the transmitted wave or the reflected wave when the determination result of the determination unit is affirmative.

The present invention may be described as a detection program for detecting a target object. In this case, the detection program according to the present invention is a detection program causing a computer to perform the steps of the above-mentioned detection method.

While the embodiments of the present invention have been described, the present invention is not limited to the above-mentioned embodiments but can be modified in various forms without departing from the concept of the present invention.

For example, although the transmitting output power is adjusted as the transmitting characteristics of the transmitting unit 100 in the above-mentioned embodiment, the present invention is not limited to this example, and any transmitting characteristic of the transmitting unit 100 such as a transmitting frequency of the transmitting unit 100 may be adjusted as long as it can compensate for the attenuation of the transmitted wave or the reflected wave. The same is true of the receiving characteristics of the receiving unit 200.

Although it is described in the above-mentioned embodiment that the first condition is determined in step S4 shown in FIG. 3, the second condition is determined in step S6, and the third to fifth conditions are determined in step S10, the present invention is not limited to this example, and these conditions may be determined in parallel and it may be determined whether or not the radar apparatus is located in the vehicle interior, based on the combination of the satisfied conditions. For example, the first to fifth conditions may be determined sequentially or in parallel and it may be determined that the radar apparatus is located in the vehicle interior at the aiming state when only the first condition is satisfied. For example, when the third to fifth conditions are satisfied, the other conditions may be ignored and it may be determined that the radar apparatus is located in the vehicle exterior of the traveling vehicle.

What is claimed is:

1. An on-board radar apparatus comprising:
a transmitting unit configured to transmit a transmitted wave;
a receiving unit configured to receive a reflected wave obtained by causing an object to reflect the transmitted wave, to generate a reception signal, and to detect the object by performing a signal process on the reception signal;
a determination unit configured to determine whether or not the on-board radar apparatus is located in a vehicle interior; and
an adjustment unit configured to adjust transmitting characteristics of the transmitting unit or receiving characteristics of the receiving unit so as to compensate for an attenuation in a propagation path of the transmitted wave or the reflected wave when the determination result of the determination unit is affirmative.

2. The on-board radar apparatus according to claim 1, wherein the adjustment unit adjusts the transmitting characteristics by increasing a transmitting output power of the transmitting unit depending on the attenuation.

3. The on-board radar apparatus according to claim 1, wherein the adjustment unit adjusts the receiving characteristics by increasing a receiving gain of the receiving unit depending on the attenuation.

4. The on-board radar apparatus according to claim 1, wherein the adjustment unit adjusts the receiving characteristics by multiplying a coefficient corresponding to an increase in receiving gain of the receiving unit based on the attenuation by a signal component obtained in the course of causing the receiving unit to perform the signal process on the reception signal.

5. The on-board radar apparatus according to claim 1, wherein the radar apparatus is housed in the same casing as a camera apparatus.

6. A detection method using an on-board radar apparatus having a transmitting unit configured to transmit a transmitted wave and a receiving unit configured to receive a reflected wave obtained by causing an object to reflect the transmitted wave, to generate a reception signal, and to detect the object by performing a signal process on the reception signal, the detection method comprising the steps of:
determining whether or not the on-board radar apparatus is located in a vehicle interior; and
adjusting transmitting characteristics of the transmitting unit or receiving characteristics of the receiving unit so as to compensate for an attenuation in a propagation path of the transmitted wave or the reflected wave when the determination result is affirmative.

7. A detection program causing a computer of an on-board radar apparatus, which comprises a transmitting unit configured to transmit a transmitted wave and a receiving unit configured to receive a reflected wave obtained by causing an object to reflect the transmitted wave, to generate a reception signal, and to detect the object by performing a signal process on the reception signal, to perform the sequences of:
determining whether or not the on-board radar apparatus is located in a vehicle interior; and
adjusting transmitting characteristics of the transmitting unit or receiving characteristics of the receiving unit so as to compensate for an attenuation in a propagation path of the transmitted wave or the reflected wave when the determination result is affirmative.
